(19) United States
(12) Patent Application Publication
(10) Pub. No.: US 2011/0274288 A1
(43) Pub. Date: Nov. 10, 2011

(54) ELECTROMAGNETIC TRANSDUCER

(76) Inventors: LIN-ZHEN LI, Shenzhen (CN); Suo-He Wei, Shenzhen (CN)

(21) Appl. No.: 12/978,598

(22) Filed: Dec. 26, 2010

(30) Foreign Application Priority Data
May 10, 2010 (CN) 201020192233.3

(51) Int. Cl. H04R 1/02

(52) U.S. Cl. 381/87

(57) ABSTRACT

An electromagnetic transducer is disclosed. The electromagnetic transducer includes a holder forming a hollow space, a suspension mounted on the holder, a vibrating member suspended in the hollow space by the suspension, a diaphragm arranged facing the vibrating member. The outlines of the diaphragm, the vibrating member and the suspension are the same. The electromagnetic transducer provides sound producing and vibration functions.

### FIELD OF THE INVENTION

The present invention relates to electromagnetic transducers, and more specifically to an electromagnetic transducer using a single magnet to provide multiple functions.

### DESCRIPTION OF RELATED ART

A typical electromagnetic transducer has only one simple function. Inputted electric energy causes the sound coil and a magnet of the electromagnetic transducer to produce a coupling effect and to further move a vibration panel. When the vibration panel is vibrated, air molecules contacting the vibration panel are excited to produce a variable dense-disperse wave (longitudinal wave). The amount of variation of the dense-disperse wave is the waveform of sound pressure audible to human ears.

However, the electromagnetic transducer can only produce a magnetic loop to convert electric energy into sound energy without any other added functions. Therefore, while installed in an electronic telecommunication apparatus (for example, a cellular phone), two component parts are required to achieve sound producing and vibration functions. In recent years, it has been the market tendency to make electronic apparatus thinner and smaller and to provide electronic telecommunication apparatus with user-friendly operation interfaces. When designing the electromagnetic transducer, which is a key component for electronic telecommunication apparatus, factors of high performance, low consumption of power, flat and compact outer appearance, and low cost should be taken into account.

So, it is necessary to provide a new multifunctional vibrating actuator for solving the problem mentioned above.

### BRIEF DESCRIPTION OF THE DRAWINGS

FIG. 1 is an illustrative cross-sectional view of an electromagnetic transducer according to an exemplary embodiment of the present invention;

FIG. 2 is an illustrative isometric view of a suspension of the electromagnetic transducer actuator;

FIG. 3 is an illustrative isometric view of a yoke of the electromagnetic transducer;

FIG. 4 is an illustrative isometric view of a magnet of the electromagnetic transducer; and

FIG. 5 is an illustrative isometric view of a weight of the electromagnetic transducer.

### DETAILED DESCRIPTION OF THE EMBODIMENT

Reference will now be made to describe the exemplary embodiment of the present invention in detail.

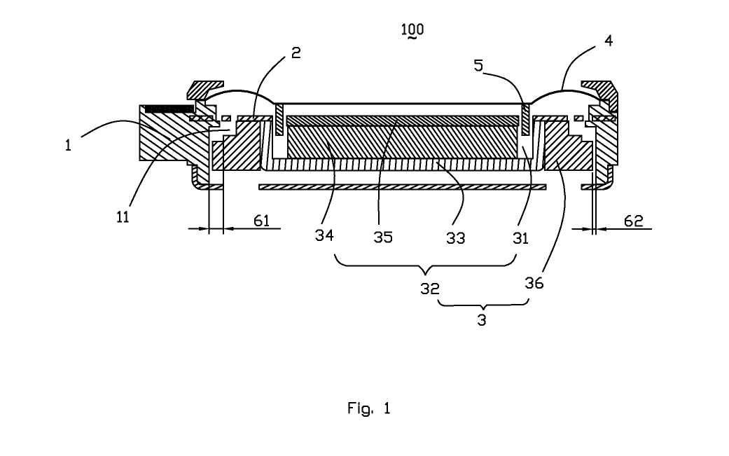

Referring to FIG. 1 through FIG. 5, an electromagnetic transducer 100 comprises a holder 1 forming a hollow space 11, a suspension 2 assembled with the holder 1, a vibrating member 3 suspended in the hollow space 11 by the suspension 2 and defining a magnetic gap 31, a diaphragm 4 arranged facing the vibrating member 3 with a periphery thereof fixed to the holder 1, and a voice coil 5 attached to a lower surface of the diaphragm 4 with a part thereof inserted into the magnetic gap 31 of the vibrating member 3.

Referring to FIGS. 1, 3 and 4, the vibrating member 3 defines a magnetic circuit part 32 and a weight 36 assembled with the magnetic circuit part 32. The magnetic circuit part 32 comprises a yoke 33, a magnet 34 receiving in the yoke 33 and a pole plate 35 attached to a top surface of the magnet 34. Referring to FIG. 4, the yoke 33 defines four first linear portions 331 and four first arc portions 332 each smoothly connecting two adjacent first linear portions 331. Referring to FIG. 5, the magnet 34 defines four second linear portions 341 and four second arc portions 342 each smoothly connecting the two adjacent second linear portions 341. It is optional that each arc portion is configured to be a part of a circle. In the present exemplary embodiment, the vibrating member is a type of two-piece and the weight 36 is separated with the yoke. In fact, the weight 36 may be an integral part of the vibrating member.

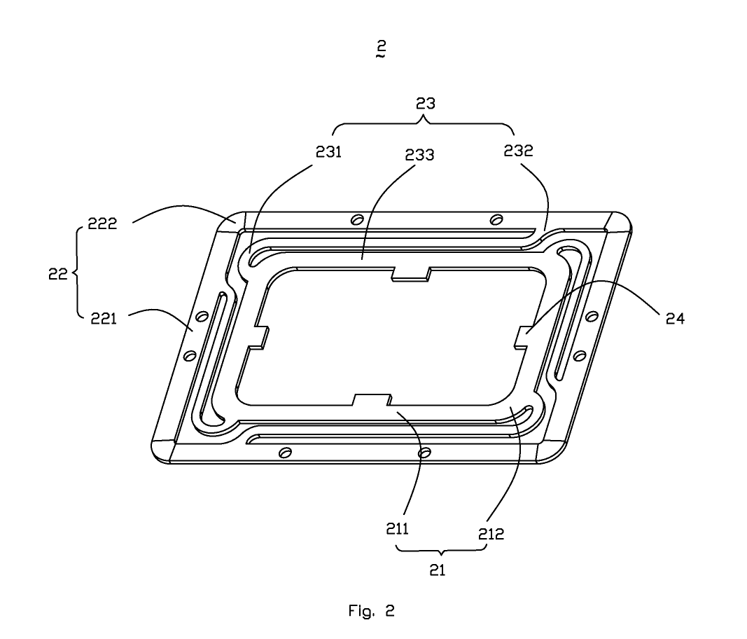

Referring to FIG. 2, the suspension 2 defines an inner ring portion 21, an outer ring portion 22 surrounding the inner ring portion 21, and at least a pair of connecting portions 23 disposed between and connecting the inner ring portion 21 and the outer ring portion 22. The inner ring portion 21 of the suspension 2 defines four first straight segments 211 and four first arcuate segments 212 each smoothly connecting with two adjacent first straight segments 211. The outer ring portion 22 of the suspension 2 includes four second straight segments 221 and four second arcuate segments 222 each smoothly connecting with two adjacent second straight segments 221. Each connecting portion 23 defines a first end 231 connected to the inner ring portion 21, a second end 232 connected to the outer ring portion 22, and a middle portion 233 extending between and connecting with the first and second ends 231, 232. The middle portion 233 of the suspension 2 is parallel to the straight segments 211, 221 between which the middle portion 233 is located.

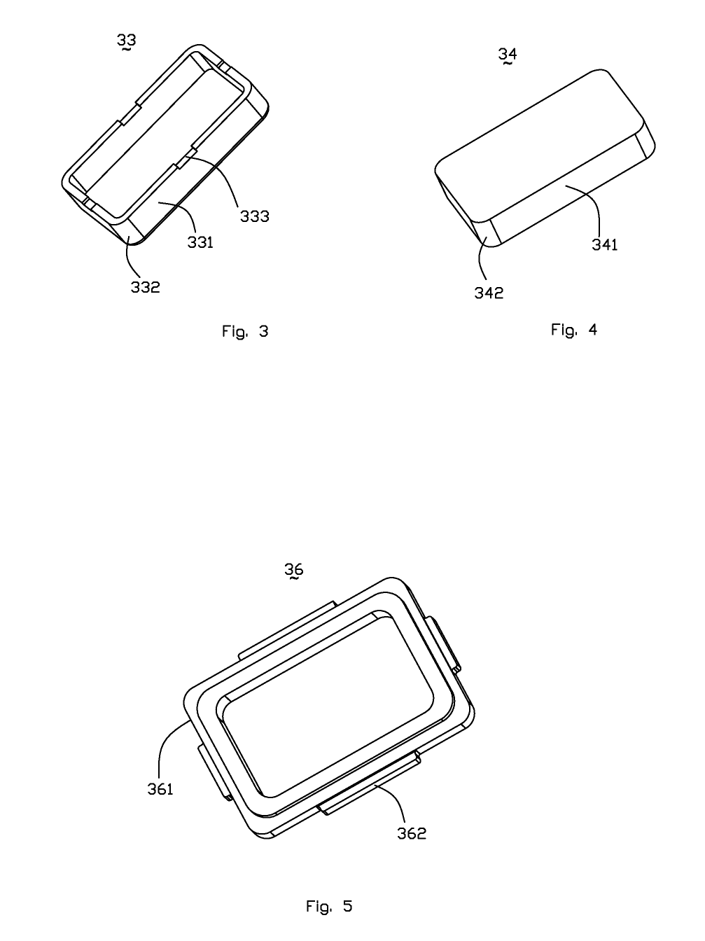

Referring to FIG. 2 and FIG. 3, the suspension 2 further defines at least a pair of fastening portions 24 projecting from the inner ring portion 21 toward a center of the suspension 2, and the yoke 33 defines a pair of securing portion 333 for engaging with the fastening portions 24 for assembling the suspension 2 with the yoke 33 firmly.

Referring to FIGS. 1 and 5, the weight 36 defines a surrounding wall 361 forming a first gap 61 with an inner side of the holder 1 and a plurality flanges 362 projecting from the surrounding wall 361 towards the inner side of the holder 1 for forming a second gap 62 with the inner side of the holder 1, the first gap 61 being communicated with the second gap 62. It is optional that a width of the second gap 62 is more than 0 but not more than 0.2 mm and the first gap 61 is more than 0.2 mm.

Referring to FIG. 1, the voice coil 5 is partially inserted into the magnetic gap 31 and spaced apart from the yoke 33 and magnet 34 at a predetermined distance.

The outline of the diaphragm 4 is similar to the suspension 2.

According to the electromagnetic transducer, providing sound producing and vibration functions, the outline of the suspension is rectangular with rounded corners. And the outlines of the magnetic circuit part, the diaphragm and the suspension are same to each other. The magnetic flux density exerting on the diaphragm is equal. Thus, the vibrating of the diaphragm is stable and balanced.

The present invention meets the electronic telecommunication apparatus's current design focus, which is characterized in being thinner, smaller, and shorter, and greatly reducing material cost and assembly cost.

While the present invention has been described with reference to the specific embodiment, the description of the invention is illustrative and is not to be construed as limiting the invention. Various of modifications to the present invention can be made to the exemplary embodiment by those skilled in the art without departing from the true spirit and scope of the invention as defined by the appended claims.

What is claimed is:

1. An electromagnetic transducer, comprising:
a holder forming a hollow space;
a suspension assembled with the holder and defining an inner ring portion, an outer ring portion surrounding the inner ring portion, and at least a pair of connecting portions disposed between and connecting the inner ring portion and the outer ring portion, the inner ring portion of the suspension defining four first straight segments and four first arcuate segments each smoothly connecting two adjacent first straight segments, the outer ring portion of the suspension defining four second straight segments and four second arcuate segments each smoothly connecting two adjacent second straight segments;
a vibrating member suspended in the hollow space by the suspension, the vibrating member defining a yoke, a magnet received in the yoke and forming a magnetic gap together with the yoke, the yoke defining four first linear portions and four first arc portions each smoothly connecting two adjacent first linear portions, the magnet defining four second linear portions and four second arc portions each smoothly connecting two adjacent second linear portions;
a diaphragm arranged facing the vibrating member, an outline of the diaphragm being substantially same to that of the suspension;
a voice coil attached to the diaphragm, partially inserted into the magnetic gap, and spaced apart from the yoke and magnet at a predetermined distance.

2. The electromagnetic transducer as described in claim 1, each arc portion is configured to be a part of a circle.

3. The electromagnetic transducer as described in claim 1, each arcuate segment is configured to be a part of a circle.

4. The electromagnetic transducer as described in claim 1, wherein each connecting portion defines a first end connected to the inner ring portion, a second end connected to the outer ring portion, and a middle portion located between and connected to the first and second ends.

5. The electromagnetic transducer as described in claim 4, wherein the middle portion is parallel to the straight portions between which the middle portion is located.

6. The electromagnetic transducer as described in claim 1, wherein the vibrating member further defines a weight integral with or attached to a periphery of the yoke.

7. The electromagnetic transducer as described in claim 1, wherein the suspension defines at least a pair of fastening portions projecting from the inner ring portion towards a center of the suspension and the yoke defines a pair of securing portion for engaging with the fastening portions.

8. The electromagnetic transducer as described in claim 6, wherein the weight defines a surrounding wall for forming a first gap with an inner side of the holder and a plurality flanges projecting from the surrounding wall towards the inner side of the holder for forming a second gap communicating with the first gap with the inner side of the holder.

9. The electromagnetic transducer as described in claim 8, wherein a width of the second gap is more than 0 but not more than 0.2 mm.

10. The electromagnetic transducer as described in claim 9, wherein a width of the first gap is more than 0.2 mm.

11. A multifunctional vibrating actuator, comprising:
a housing;
a magnetic circuit part accommodated in the housing and defining a magnetic gap;
a suspension for elastically supporting the magnetic circuit part in the housing;
a diaphragm arranged facing the magnetic circuit part;
a voice coil attached to the diaphragm, partially inserted into the magnetic gap, and spaced apart from the yoke and magnet at a predetermined distance;
wherein, the outlines of the magnetic circuit part, the diaphragm and the suspension are same to each other.

12. The multifunctional vibrating actuator as described in claim 11, wherein the outline of the suspension is rectangular with rounded corners.

13. The multifunctional vibrating actuator as described in claim 11, wherein the multifunctional vibrating actuator further defines a weight integral with or attached to a periphery of the yoke.

14. The multifunctional vibrating actuator as described in claim 11, wherein the suspension defines at least a pair of fastening portions projecting from the inner ring portion towards a center of the suspension and the yoke defines a pair of securing portion for engaging with the fastening portions.

15. The multifunctional vibrating actuator as described in claim 13, wherein the weight defines a surrounding wall for forming a first gap with an inner side of the holder and a plurality flanges projecting from the surrounding wall towards the inner side of the holder for forming a second gap communicating with the first gap with the inner side of the holder.

16. The multifunctional vibrating actuator as described in claim 15, wherein a width of the second gap is more than 0 but not more than 0.2 mm.

17. The multifunctional vibrating actuator as described in claim 16, wherein a width of the first gap is more than 0.2 mm.
